(19) United States
(12) Patent Application Publication
(10) Pub. No.: US 2007/0127439 A1
(43) Pub. Date: Jun. 7, 2007

(54) Method and apparatus for enabling voice dialing of a packet-switched telephony connection

(76) Inventor: Robert C. Stein, Coopersburg, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/292,622

(22) Filed: Dec. 2, 2005

(51) Int. Cl. H04L 12/28; G06F 15/00; H04L 12/56; H04L 12/66; G10L 11/00

(52) U.S. Cl. 370/352; 370/401; 370/395.2; 704/200

(57) ABSTRACT

A method and apparatus provides a packet-switched telephony service over a broadband communications network. The apparatus may be a residential gateway that includes data terminal equipment having an interface for communicating with customer premises equipment. The apparatus also includes a processor configured to receive a voice utterance of a user and initiate a packet-switched telephony connection over the broadband communications network based on the voice utterance.

### FIELD OF THE INVENTION

This invention relates generally to the provision of real-time services over a packet network, and more particularly to the provision of Internet telephony to transport voice and data over an HFC network.

### BACKGROUND OF THE INVENTION

Today, access to the Internet is available to a wide audience through the public switched telephone network (PSTN). Typically, in this environment, a user accesses the Internet though a full-duplex dial-up connection through a PSTN modem, which may offer data rates as high as 56 thousand bits per second (56 kbps) over the local-loop plant.

However, in order to increase data rates (and therefore improve response time), other data services are either being offered to the public, or are being planned, such as data communications using full-duplex cable television (CATV) modems, which offer a significantly higher data rate over the CATV plant than the above-mentioned PSTN-based modem. Services being offered by cable operators include packet telephony service, videoconference service, T1/frame relay equivalent service, and many others.

Various standards have been proposed to allow transparent bi-directional transfer of Internet Protocol (IP) traffic between the cable system headend and customer locations over an all-coaxial or hybrid-fiber/coax (HFC) cable network. One such standard, which has been developed by the Cable Television Laboratories, is referred to as Interim Specification DOCSIS 1.1. Among other things, DOCSIS 1.1 specifies a scheme for service flow for real-time services such as packet telephony (“Voice over IP”). Packet telephony may be used to carry voice between telephones located at two endpoints. Alternatively, packet telephony may be used to carry voice-band data between endpoint devices such as facsimile machines or computer modems.

Voice dialing has become commonplace in PSTN networks and especially in the cellular environment. Conventional telephone systems use speech recognition technology to enable voice-activated dialing services and voice-activated directory assistance. With these systems, a directory receives a spoken name, a speech recognition process recognizes the received name, and system elements use the recognized name to find the corresponding telephone number. Once the number is located, a call is then launched to the desired destination. The speech recognition process that is employed may be either a speaker-dependent or a speaker-independent process.

### SUMMARY OF THE INVENTION

A method and apparatus is shown for providing packet-switched telephony service over a broadband communications network. The apparatus may be a residential gateway that includes data terminal equipment having an interface for communicating with customer premises equipment. The apparatus also includes a processor configured to receive a voice utterance of a user and initiate a packet-switched telephony connection over the broadband communications network based on the voice utterance.

In one particular example, the residential gateway of claim 1 also includes a broadband modem for communicating data between the data terminal equipment and the broadband communications network.

In another example the voice utterance of the user identifies a selected party with a voice entry identifying the selected party. The selected party is selected from among a plurality of parties each having a telephone number and a voice entry identifying the respective party. The residential gateway also includes a digital memory configured to store the voice entry and the telephone number associated therewith of each party.

In another example, the residential gateway also includes a first electronic memory segment in which a speech recognition algorithm is stored to perform the matching.

In another example, the residential gateway also includes a second electronic memory segment configured to store a directory that associates each of the voice entries with its corresponding telephone number.

In yet another example, the residential gateway also includes a third electronic memory segment storing a plurality of menu-driven voice prompts to be communicated to the user during a voice activation process.

In another example, the customer premises equipment is a telephone.

In another example, the residential gateway also includes a program electronic memory segment that stores executable instructions for controlling operation of the data terminal equipment to implement a voice recognition engine.

In another example, the data terminal equipment includes a CODEC for converting voice signals to and from voice data and a DSP for processing the voice data. The executable instructions control the operation of the DSP to implement the voice recognition engine.

In another example, the packet-switched telephony connection conforms to a voice-over-IP protocol.

A method of initiating a packet telephony call over a broadband communications network begins by receiving from a telephone a first signal representative of a voice utterance that identifies a party to be called. A packet-switched telephony connection is initiated over the broadband communications network based on the voice utterance.

### BRIEF DESCRIPTION OF THE DRAWING

FIG. 1 shows an illustrative voice-over-IP communications system.

FIG. 2 is an illustrative flowchart describing how a telephone entry may be created.

FIG. 3 is an illustrative flowchart describing how the user may place a call by a voice dialing process.

### DETAILED DESCRIPTION

As detailed below, a voice dialing arrangement is provided in a packet telephony arrangement such as a voice-over-IP system.

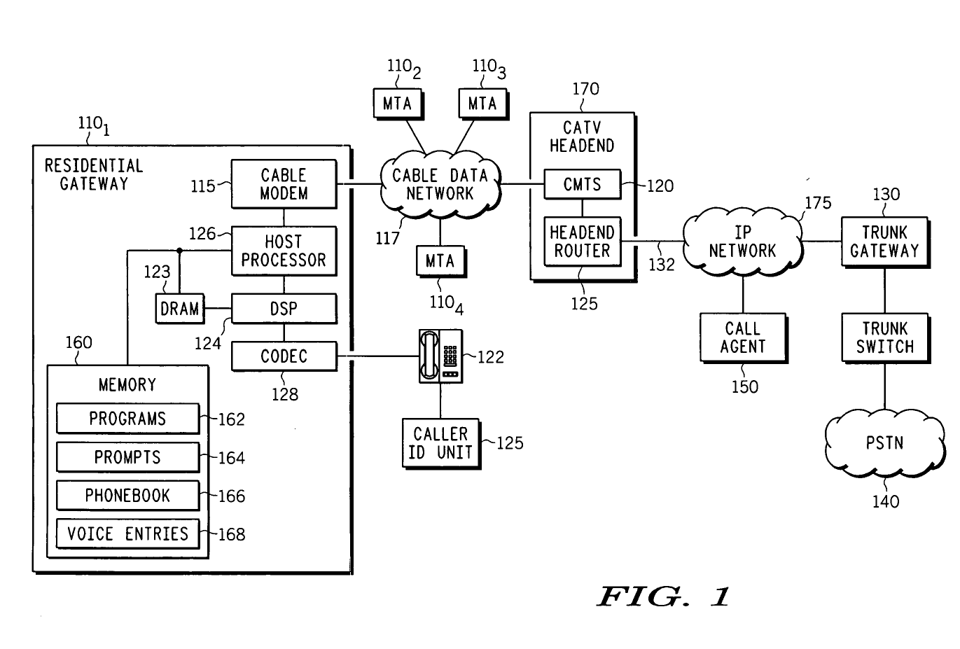

An illustrative broadband access network is shown in FIG. 1. Access network 100 is representative of a network architecture in which subscribers associated with subscriber or residential gateways such as embedded multi-media terminal adapters (eMTAs) or stand-alone multi-media terminal adapters (sMTAs) may access the Internet 175 and a Public Switched Telephone Network (PSTN) 140. In particular, MTAs 110₁-110₄ are in communication with the Internet 175 via a CATV network. Cable TV network access or IP TV network access is provided by an MSO (Multi-Service Operator) (not shown). In this context, it is assumed the MSO provides (besides the traditional CATV, or more recently, through Internet Protocol TV, access network facilities exemplified by communications network 117) CATV head-end 170 and cable modem 115. This CATV network arrangement is also referred to herein as a cable data network. CATV network is typically an all-coaxial or a hybrid-fiber/coax (HFC) cable network. MTAs 110₁-110₄ is also in communication with PSTN 140 via the cable network, IP network 175, and trunk gateway 130. Of course, other broadband access networks such as xDSL (e.g., ADSL, ADLS2, ADSL2+, VDSL, and VDSL2) may also be employed. In some of these access networks the MTA is sometimes referred to as an analog telephony adaptor (ATA).

As shown in FIG. 1 for residential gateway or MTA 110₁, the MTAs 110₁-110₄ include customer premises equipment 122, e.g., a telephone, a CODEC 128, a Digital Signal Processor (DSP) 124, host processor 126 and Cable Modem (CM) 115. CODEC 128, DSP 124, and host processor 126 are collectively representative of data terminal equipment, which is coupled to communications link 117 via CM 115 to provide communications services to a user of telephone 122. CM 115 provides the access interface to the cable data network via an RF connector and a tuner/amplifier (not shown). Broadly speaking, DSP 124 generates data packets from the analog signals received from the telephone 122. That is, DSP 124 and CODEC 128 collectively perform all of the voice band processing functions necessary for delivering voice and voice-band data over a cable network, including echo cancellation, packet loss concealment, call progress tone generation, DTMF/pulse and fax tone detection, audio compression and decompression algorithms such as G. 723 and G. 729, packet dejittering, and IP packetization/depacketization. Typically, DSP 124 encodes the data with pulse code modulated samples digitized at rates of 8, 16 or 64 kHz. Host processor 126 receives the data packet from the DSP 124 and adds an appropriate header, such as required by the MAC, IP, and UDP layers. Once the packet is complete, it is sent to CM 115, where it remains in a queue until it is transmitted over the cable data network to the CMTS 120 in the CATV headend 170. For the purposes of the present invention, the service being provided is assumed to be a real-time service such as packet telephony. Accordingly, the data packets should be formatted in accordance with a suitable protocol such as the Real-Time Transport Protocol (RTP).

In other broadband access networks the CM 115 is replaced with a broadband modem suitable for use with the standards and protocols employed by that network. For example, in an xDSL access network, the functionality of the CM 115 would be performed by an xDSL modem.

An Internet Service Provider (ISP) provides Internet access. In the context of FIG. 1, it is assumed an ISP provides IP network 175, which includes a cable data network access router (not shown) attached to communications link 132. It should be noted that for illustrative purposes only it is assumed that the above-mentioned MSO and ISP Service provider are different entities even though this is not relevant to the inventive concept.

CM 115 is coupled to CATV head-end 170 via cable network 117, which is, e.g., a CATV radio-frequency (RF) coax drop cable and associated facilities. CATV head-end 170 provides services to a plurality of downstream users (only one of which is shown) and comprises cable modem data termination system (CMTS) 120 and head-end router 125. (CMTS 120 may be coupled to head-end router 125 via an Ethernet 100BaseX connection (not shown).) CMTS 120 terminates the CATV RF link with CM 115 and implements data link protocols in support of the residential service that is provided. Given the broadcast characteristics of the RF link, multiple residential customers and, hence, potentially many home-based LANs may be serviced from the same CMTS interface. Also, although not shown, those of skill in the art will readily appreciate that the CATV network may include a plurality of CMTS/head-end router pairs.

CM 115 and CMTS 120 operate as forwarding agents and also as end-systems (hosts). Their principal function is to transmit Internet Protocol (IP) packets transparently between the CATV headend and the customer location. Interim Specification DOCSIS 1.1 has been prepared by the Cable Television Laboratories as a series of protocols to implement this functionality.

In a full voice-over-Internet communication system, a Call Agent 150 is the hardware or software component that provides the telephony intelligence in the communications system and is responsible for telephone call processing. In particular, Call Agent 150 is responsible for creating the connections and maintaining endpoint states required to allow subscribers to place and receive telephone calls, to use features such as call waiting, call forwarding and the like. In a switched IP communication system, an IP digital terminal connected to a CLASS5 telephony switch substitutes for the Call Agent and trunk gateway. In such a system, IP-based call signaling is conducted between the MTA and IPDT and GR303 or V5.2 call signaling is conducted between IPDT and telephony switch and IP voice traffic is conducted between the MTA and IPDT.

To implement voice dialing functionality, MTA 110₁ includes a memory 160. The memory 160 may be comprised of any type of computer-readable media, such as ROM, RAM, SRAM, FLASH, EEPROM, or the like. In particular, the memory 160 comprises non-volatile forms of memory such as ROM, Flash, or battery-backed SRAM such that programmed and user entered data is not required to be reloaded in the event of a power failure. Furthermore, the memory 160 may take the form of a chip, a hard disk, a magnetic disk, and/or an optical disk. Memory 160 may be logically (and possibly physically) divided into program memory segment 162, prompt memory segment 164, phone directory memory segment 166 and voice entry memory segment 168. It will be appreciated that if the memory segments are physically divided, they need not all be of the same type. For instance, program memory segment 162 may be ROM while voice entry memory segment 168 may be Flash or other non-volatile read/write memory in order to allow the user to store new spoken entries for recognition. Additionally, each of these memory segments may themselves comprise a mixture of types, for instance either or both memories may include a small amount of RAM for use as transient, or temporary, storage during processing.

For use in controlling the operation of the voice dialing process, the program memory segment 162 includes executable instructions that are intended to control the operation of the digital signal processor 124 to implement a voice recognition engine (VRE). The voice entry memory segment 168 stores the voice entries that identify the parties who are included in the phone directory. In this regard, the stored voice entries to which the voice signals are compared may be words and/or spoken alphanumeric symbols. For example, a voice entry “Mom” may be stored as the spoken word “Mom” or by the individual letters “M-O-M.” If alphanumeric symbols are employed, the user may be provided with visual feedback of the stored entries on the telephone display (if available), or on a caller id display, either integral to the telephone or in a separate caller id device using caller ID on call waiting signaling, which will be discussed in more detail below.

Each stored voice entry is associated with and identified by a particular entry number. The phone book memory segment 166 stores each entry number and a phone number that corresponds to the entry number. In this way the voice entries in voice entry memory segment 168 are associated with a particular phone number in phone book memory segment 166. The phone number that is stored may be any appropriate address needed to establish communication with the party being called, such as a phone number, an IP or other network address, and the like. Prompts memory segment 164 stores recorded voice prompts (using real or synthesized audio segments) that are used to guide the user through the various voice activation processes such as placing calls, storing new entries, and editing and deleting entries.

The voice recognition engine implemented by DSP 124 using the executable instructions and voice recognition algorithms stored in program memory segment 162 may compare the spoken name uttered by the user with the voice entries stored in voice entry memory segment 168 and determines if the spoken or uttered name is sufficiently similar to any of the stored entries. If the determining process reveals a match, a phone number associated with the most similar voice entry is retrieved from phone book memory segment 166, which is then automatically dialed to place the call. The voice recognition algorithm that is employed may be a well known algorithm that can establish a match in any of a variety of different ways. For example, the algorithm may cause the DSP 124 to extract a set of semantic feature characteristics from the stored voice entries and the spoken names spoken by the user. The feature extraction process essentially removes components that are unnecessary for automatic speech recognition purposes and leaves behind a signal made up of the essential, or semantic, speech components. In the English language, for example, among the components removed from the audio signal would be tone and pitch. Instead of feature extraction, other techniques may be employed which range in sophistication from relatively rudimentary to the more complex (e.g., hidden Markov models). Of course, DSP 124 can be programmed to perform any number of conventional feature extraction techniques generally used in conjunction with speech recognition algorithms located in program memory segment 162 to achieve word recognition and/or alphanumeric character recognition. Moreover, while speaker independent speech recognition may be generally suitable, speaker dependent speech recognition techniques may also be employed. A description of such conventional recognition techniques, which are well known in the art, may be found in many publications, such as in the reference entitled “Automatic Speech Recognition, The Development of the SPHINX System”, by Kai-Fu Lee, Kluwer Academic Publishers, and in the reference entitled “Digital Speech Processing, Synthesis, and Recognition”, by Sadaoki Fururi, Marcel Dekker, Inc. Publishing, in Chapter 8. Generally, in a speaker dependent speech recognition configuration a speaker is identified, and only words or phrases which are spoken by the identified speaker are recognized. In a speaker independent speech recognition configuration specific words are recognized, regardless of the person who speaks them. These configuration specific words or templates may be stored in the voice entry memory segment 168 or other memory segment.

CODEC 128 performs a number of different steps in the voice dialing process. For example, the CODEC 128 converts spoken names received from telephone 122 to audio data and transmits the audio data to the DSP 124, which then temporarily stores the spoken audio data in a voice memory 123 that may be, for example, a DRAM. The audio data in voice memory 123 is compared with the voice entries stored in voice entry memory segment 168. The CODEC 128 also decodes the audio data received from the DSP 124, which in turn has been retrieved from memory 160 (e.g., either from prompts memory segment 164 or voice entry memory segment 168). The decoded audio data is transformed to an audio signal by the CODEC 128 and output through a speaker in the telephone 122.

The DSP 124 digitally processes and compresses (if necessary) the audio data received from the CODEC 128 and stores the processed audio data (not including any ancillary overhead service or control data used in placing the call) in the voice memory 160. DSP 124 also reads compressed audio data from the voice memory 160, digitally processes and decompresses the read audio data, and transmits the processed data to the CODEC 128. The DSP 124 also compares the audio data in memory 123 with the voice entries stored in voice entry memory segment 168 under the direction of instructions and algorithms stored in program memory segment 162 in order to identify appropriate matches. In some cases the DSP 124 simply compares the audio data as it is stored in voice entry memory 168 (e.g., in a feature extracted form) with the spoken audio data as it is stored in memory 123. That is, there may be no need to process and decompress the audio data in voice entry memory 168 before making the comparison.

Many consumer telephones include a display for displaying such information as the telephone number and/or name of the party that is being dialed. If the user has subscribed to a caller ID service, the display can also provide the name and telephone number of an incoming caller. It should be noted that caller ID can be classified into two types. Caller ID which is received when the phone is not in-use (on-hook), and which is usually accompanied by ringing, is called type I caller ID. Caller ID which is received when the phone is already in-use (off-hook) is called type II caller ID, or caller ID on call waiting. With caller ID on call waiting, the second caller's identifying information is received and displayed to the called party. This allows the called party to know who is calling, enabling a decision as to whether the called party wants to switch to the second call or not. The successful transmission of call-waiting caller ID information requires a successful handshaking operation during the transmission that is based on well known Telecordia signaling standards. The handshaking involves an exchange of signals between the central telephone switch and the called party's telephone.

The aforementioned signaling standards conventionally used to provide a caller ID on call waiting service can be used in the present situation to display the telephone directory information stored by the user in the residential gateway or MTA. That is, after the user speaks the name of a party to be called during the voice dialing process, caller ID on call waiting protocols can be used to transmit the name and telephone number of the selected party retrieved from directory memory segment 166 to the display of telephone 122. This information can then be used to confirm that the correct party has been selected.

If the telephone 122 that is employed is not a caller ID telephone integrated with a display, a stand-alone caller ID adjunct unit such as unit 125 may be employed to take advantage of this feature. In some cases the MTA itself may incorporate a cordless phone base station and handset that includes a display, which can be used to display the telephone directory information stored by the user in the MTA.

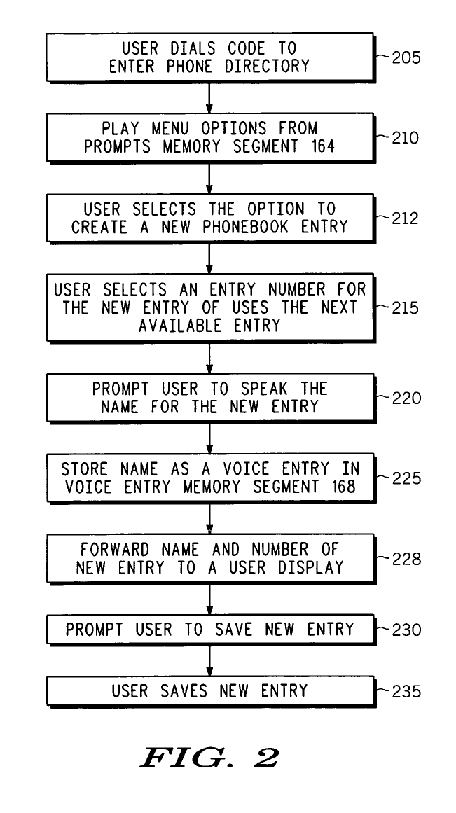

FIG. 2 is an illustrative flowchart describing how a voice dial telephone entry may be created, including a name dial entry. Those of skill in the art may appreciate that a voice recognition engine may permit voice activated number dialing without preprogramming. In step 205 the user picks up the handset of the telephone 122 or otherwise places the telephone 122 into an off-hook state and dials a special code to enter the phone directory. The user may then be presented in step 210 with a menu of options that is retrieved from prompts memory segment 164. One such option may be “to create a new phonebook entry, press 9.” After pressing or otherwise selecting the appropriate number (e.g., 9) in step 212 the user may be presented with another option in step 215 to select a phone directory entry by number or to press, a key to select the next available entry, such as the “*” key. The user may then be prompted in step 220, such as by retrieval of another prompt from memory segment 164, to speak a name for the new entry. Alternatively, the user may be prompted to type the associated name on the handset keypad, and the voice recognition engine may be configured to recognize the associated name without being preprogrammed by the user speaking the name. In step 225 voice data associated with the name, such as the name or some extracted rendition of the name, depending on the particular voice recognition process that is employed, is then stored as a voice entry in voice entry memory segment 168. The user may also be asked to spell the name. In any case, to ensure accuracy the user may be asked to repeat the name or spelling, after which the name may be repeated or spelled back. Optionally, in step 228, the telephone number and name of the party may be forwarded to the telephone 122 or stand-alone caller ID unit, if such functionality is available. Finally, the user may be prompted to save the new entry in step 230 by selecting a number on the keypad or to erase the entry and start over by selecting another number on the keypad. The user then saves the entry in step 235, thereby completing the creation of the new telephone entry.

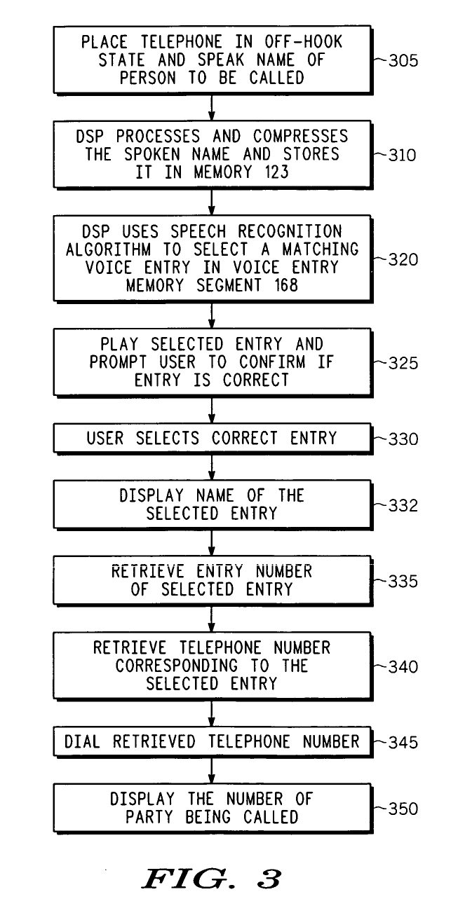

FIG. 3 is a flowchart describing how the user places a call using the telephone directory. The process begins in step 305 when the user picks up the handset of the telephone 122 or otherwise places the telephone 122 into an off-hook state and speaks the name of the person to be called (in some cases the user may first be required to enter a special code before activating voice dialing, in other cases voice dialing may be the default mode of operation when the phone is off-hook). In step 310 the DSP 124 processes and compresses the spoken name and temporarily stores the compressed audio data in memory 123. Next, in step 320 DSP 124 retrieves the appropriate voice recognition algorithm from program memory segment 162 and compares the compressed audio data to each of the voice entries in voice entry memory segment 168 until a match is found. The selected voice entry may be played for the user in step 325 along with a prompt that asks the user if in fact the correct entry has been retrieved. The user responds with a “yes” or “no” in step 330. Optionally, in step 332, the name of the party may be displayed on the telephone's display of the stand-alone Caller ID unit using caller ID on call waiting signaling, if available. If the user responds with no, another entry that forms the next best match is selected. When the user finally responds with a “yes,” the entry number corresponding to the correct voice entry is retrieved in step 335 from voice entry memory segment 168. In some cases the user may effectively indicate a “yes” response simply by providing neither a yes or no response for a pre-determined amount of time. That is, if this voice-dial response timeout expires, the residential gateway proceeds as if a “yes” response has been made. DSP 124 then retrieves the phone number corresponding to that entry number from phone book memory segment in step 340 and, in step 345, dials the retrieved phone number. Optionally, in step 350, the telephone number of the party may be displayed on the telephone's display of the stand-alone Caller ID unit using caller ID on call waiting signaling, if available.

Although MTA 110 has been illustrated as having various components for discussion purposes, those of skill in the art will appreciate that several components illustrated in MTA 110, such as host processor 126, DSP 124, CODEC 128 and cable modem 115 may implemented in a single programmable processor. Memory 160 may constitute one or more memory components, including removable memory components. Further, telephone 122 and/or caller ID unit 125 may also be integrally formed with MTA 110.

The steps of the processes shown in FIGS. 2 and 3, which take place on MTA 110, may be implemented in a general, multi-purpose or single purpose processor. Such processor will execute instructions, either at the assembly, compiled or machine-level, to perform that process. Those instructions can be written by one of ordinary skill in the art following the description of FIGS. 2 and 3 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), and/or packetized or non-packetized wireline or wireless transmission signals.

Described above is a voice dialing arrangement for use in a packet telephony arrangement such as a voice-over-IP system. In this way functionality that is often used in PSTN and cellular networks is also made available in a packet telephony environment.

1. A residential gateway for providing packet-switched telephony service over a broadband communications network, comprising:
data terminal equipment having an interface for communicating with customer premises equipment; and
a processor configured to receive a voice utterance of a user and initiate a packet-switched telephony connection over the broadband communications network based on the voice utterance.

2. The residential gateway of claim 1 further comprising a broadband modem for communicating data between the data terminal equipment and the broadband communications network.

3. The residential gateway of claim 1 wherein the voice utterance of the user identifies a selected party with a voice entry identifying the selected party, said selected party being selected from among a plurality of parties each having a telephone number and a voice entry identifying the respective party, and further comprising a digital memory configured to store the voice entry and the telephone number associated therewith of each party.

4. The residential gateway of claim 1 further comprising a first electronic memory segment in which a speech recognition algorithm is stored to perform the matching.

5. The residential gateway of claim 4 further comprising a second electronic memory segment configured to store a directory that associates each of the voice entries with its corresponding telephone number.

6. The residential gateway of claim 5 further comprising a third electronic memory segment storing a plurality of menu-driven voice prompts to be communicated to the user during a voice activation process.

7. The residential gateway of claim 1 wherein the customer premises equipment is a telephone.

8. The residential gateway of claim 1 further comprising a program electronic memory segment that stores executable instructions for controlling operation of the data terminal equipment to implement a voice recognition engine.

9. The residential gateway of claim 8 wherein the data terminal equipment includes a CODEC for converting voice signals to and from voice data and a DSP for processing the voice data, wherein the executable instructions control the operation of the DSP to implement the voice recognition engine.

10. The residential gateway of claim 1 wherein the packet-switched telephony connection conforms to a voice-over-IP protocol.

11. A method of initiating a packet telephony call over a broadband communications network, comprising:
receiving from a telephone a first signal representative of a voice utterance that identifies a party to be called; and
initiating a packet-switched telephony connection over the broadband communications network based on the voice utterance.

12. The method of claim 1 further comprising:
selecting an identifier of the party to be called based on the first signal;
retrieving a telephone number associated with the party to be called using the selected identifier;
encoding the telephone number into a packetized format suitable for transmission over the broadband communications network; and
forwarding the telephone number in the packetized format over the broadband communications network to a call agent for establishing communication with the party to be called.

13. The method of claim 11 further comprising receiving a second signal initiating a voice dialing mode of operation.

14. The method of claim 12 wherein the packetized format conforms to a voice-over-IP protocol.

15. The method of claim 12 further comprising transmitting at least the retrieved telephone number to a display associated with the telephone in accordance with a caller ID on call waiting signaling protocol.

16. The method of claim 12 further comprising transmitting an alphanumeric representation of the party to be called to a display associated with the telephone in accordance with a caller ID on call waiting signaling protocol.

17. A computer readable medium containing instructions to cause a processor to perform a method of initiating a packet telephony call over a broadband communications network, the method comprising the steps of:
receiving from a telephone a first signal representative of a voice utterance that identifies a party to be called; and
initiating a packet-switched telephony connection over the broadband communications network based on the voice utterance.

18. The computer readable medium of claim 17 further comprising:
selecting an identifier of the party to be called based on the first signal;
retrieving a telephone number associated with the party to be called using the selected identifier;
encoding the telephone number into a packetized format suitable for transmission over the broadband communications network; and
forwarding the telephone number in the packetized format over the broadband communications network to a call agent for establishing communication with the party to be called.

19. The computer readable medium of claim 18 further comprising receiving a second signal initiating a voice dialing mode of operation.

20. The computer readable medium of claim 18 wherein the packetized format conforms to a voice-over-IP protocol.

21. The computer readable medium of claim 18 further comprising transmitting at least the retrieved telephone number to a display associated with the telephone in accordance with a caller ID on call waiting signaling protocol.

22. The computer readable medium of claim 18 further comprising transmitting an alphanumeric representation of the party to be called to a display associated with the telephone in accordance with a caller ID on call waiting signaling protocol.
